(19) United States
(12) Patent Application Publication
(10) Pub. No.: US 2025/0317534 A1
(43) Pub. Date: Oct. 9, 2025

(54) STORAGE MANAGEMENT FOR A VIDEO SURVEILLANCE SYSTEM

(71) Applicant: Genetec Inc., Montréal (CA)

(72) Inventors: Etienne Bernier GOSSELIN, Sherbrooke (CA); Weiliang XIE, Montréal (CA); Justin MIZZI, Montréal (CA)

(21) Appl. No.: 18/917,149

(22) Filed: Oct. 16, 2024

Related U.S. Application Data
(60) Provisional application No. 63/631,790, filed on Apr. 9, 2024.

(51) Int. Cl. H04N 7/18

(52) U.S. Cl. CPC H04N 7/181

(57) ABSTRACT

A video surveillance system comprising video content generated by a camera, a storage device, and a computing system adapted to receive the video content from the camera. The computing system adapted to store the video content in the storage device, determine whether the storage device will run out of storage capacity based on an operating parameter of the camera and a retention policy associated with the video content stored in the storage device, and generate an alert in response to determining that the storage device will run out of storage capacity.

### RELATED APPLICATIONS

This application claims the benefit of co-pending U.S. Provisional Patent Application No. 63/631,790, filed Apr. 9, 2024, the entire content of which is incorporated by reference.

### FIELD

The present teachings relate generally to video surveillance systems and, more particularly, to systems and methods for managing storage for a video surveillance system.

### BACKGROUND

Security systems are commonly used to monitor and protect areas of interest. Some security systems, such as video surveillance systems, can include one or more cameras that generate video content (e.g., .MP4 files) associated with an area being monitored. As a camera generates video content, the video content needs to be stored for later viewing. In this regard, a camera can transmit video content to one or more computing devices for storing the video content.

In some solutions, cameras included in a video surveillance system transmit video content to local computing devices, such as dedicated on-premises servers, for storage. When compared to cloud-based storage on a remote server, storing video content locally in an on-premises server can be a relatively inexpensive option. However, because the storage capacity of an on-premises, or local, server is limited, video content generated by the cameras included a video surveillance system can be lost if the local server runs out of storage capacity.

In other solutions, cameras included in a video surveillance system transmit video content to remote computing devices, such as remote servers, for cloud-based storage. When compared to a dedicated on-premises server, remote servers can provide additional storage capacity. However, storing video content on a remote server can be very expensive. For example, in scenarios in which the amount of video content to be stored exceeds an allotted amount of storage capacity in a remote server, operators of a video surveillance system can be charged with expensive excess storage fees.

To prevent losing video content and/or paying excessive fees when storage capacity runs out, some solutions predict when an amount of storage capacity available to the video surveillance system will run out based on historical patterns for storing video content generated by the cameras in the video surveillance system. Based on this prediction, the computing device can generate notifications to warn users when storage capacity available to the video surveillance system is running out. However, historical patterns for storing video content may not be reflective of current conditions of the cameras generating the video content and/or the capacity of storage devices that are storing the video content, and thus, the storage capacity predictions based on historical patterns can be inaccurate. Inaccurate storage capacity predictions can cause video content to inadvertently be lost and/or cause operators of the video surveillance system to pay for extra cloud storage capacity that is not needed.

Therefore, it would be beneficial to have an alternative system and method for managing storage for a video surveillance system.

### SUMMARY

The needs set forth herein as well as further and other needs and advantages are addressed by the present embodiments, which illustrate solutions and advantages described below.

The present teachings relate to managing storage of video content for a video surveillance system. In particular, the present teachings relate to predicting a future lack of storage capacity available to a video surveillance system and notifying users of the future lack of storage capacity. With the present teachings, a computing system can predict a future lack of storage capacity available to a video surveillance system based on operating parameters of the cameras included in the video surveillance system and the retention policies for storing video content generated by the video surveillance system.

At least one technical advantage of the present teachings relative to the prior art solutions is that, with the present teachings, more accurate predictions regarding if and/or when an amount of storage capacity available to a video surveillance system will run out can be made. In this regard, the risk of losing video content that is currently stored in a storage device and/or new video content that is generated by a camera in a video surveillance system is significantly reduced.

One embodiment of a video surveillance system according to the present teachings includes, but is not limited to, video content generated by a camera, a storage device, and a computing system adapted receive the video content from the camera. The computing system is adapted to store the video content in the storage device. The computing system is adapted to determine whether the storage device will run out of storage capacity based on an operating parameter of the camera and a retention policy associated with video content stored in the storage device. The computing system is adapted to generate an alert in response to determining that the storage device will run out of storage capacity.

In one embodiment, the computing system is further adapted to determine a remaining storage capacity of the storage device and determine when the storage device will run out of storage capacity based on the remaining storage capacity of the storage device, the operating parameter of the camera, and the retention policy associated with video content stored in the storage device.

In one embodiment, the alert indicates when the storage device will run out of storage capacity.

In one embodiment, the operating parameter of the camera includes a target quality for video content generated by the camera.

In one embodiment, the target quality for video content is derived from one or more proxy values including at least one of a frame rate value for video content generated by the camera, a resolution value for video content generated by the camera, a field of view of the camera, or a position of the camera.

In one embodiment, the operating parameter of the camera includes an amount by which a quality of the video content generated by the camera deviates from a target quality for video content generated by the camera.

In one embodiment, the operating parameter of the camera includes at least one of a bit rate or a frame rate at which the camera generates video content.

In one embodiment, the operating parameter of the camera includes a rate at which the camera transmits video content to the computing system.

In one embodiment, the retention policy includes an amount of time for which the video content generated by the camera remains stored in the storage device.

In one embodiment, the camera comprises a plurality of cameras, the retention policy comprises a first amount of time for which first video content generated by a first camera included in the plurality of cameras remains stored in the storage device, and the retention policy comprises a second amount of time for which second video content generated by a second camera included in the plurality of cameras remains stored in the storage device.

In one embodiment, the alert indicates the remaining capacity of the storage device.

In one embodiment, the alert includes a recommendation for preserving the remaining capacity of the storage device.

In one embodiment, the storage device is a local server that is connected to the computing system via a local network connection.

In one embodiment, the storage device is a remote server that is connected to the computing system via an Internet connection.

In one embodiment, the video surveillance system further comprises a plurality of display devices and a plurality of cameras.

One embodiment of a video surveillance system according to the present teachings includes, but is not limited to, a plurality of cameras adapted to generate video content, a storage device, and a computing system adapted to receive video content from the plurality of video cameras. The computing system is adapted to store the video content in the storage device. The computing system is adapted to determine a first rate at which video content is stored in the storage device based on one or more operating parameters of the plurality of cameras. The computing system is adapted to determine a second rate at which video content is removed from the storage device based on one or more retention policies associated with video content stored in the storage device. The computing system is adapted to determine whether the storage device will run out of capacity based in part on a comparison between the first rate and the second rate. Responsive to determining that the storage device will run out of capacity, the computing system is adapted to generate an alert that indicates the storage device will run out of storage capacity.

In one embodiment, the computing system comprises a plurality of processors in communication over a network.

In one embodiment, the computing system is further adapted to determine a remaining storage capacity of the storage device and determine when the storage device will run out of storage capacity based on the remaining storage capacity of the storage device, the first rate, and the second rate.

One embodiment of a video surveillance system according to the present teachings includes, but is not limited to first video content generated by a first camera, second video content generated by a second camera, a storage device, and a computing system adapted to receive the first video content from the first camera and the second video content from the second camera. The computing system is adapted to store the first video content and the second video content in the storage device. The computing system is adapted to determine whether the storage device will run out of storage capacity based in part on a first operating parameter of the first camera, a second operating parameter of the second camera, and a retention policy associated with the first video content and the second video content stored in the storage device. The computing system is adapted to generate an alert in response to determining that the storage device will run out of storage capacity.

In one embodiment, the first operating parameter of the first camera includes a first rate at which the first camera transmits video content to the computing system and the second operating parameter of the second camera includes a second rate at which the second camera transmits video content to the computing system.

In one embodiment, the first operating parameter of the first camera includes at least one of a first historical bitrate at which the first camera generates video content and a first historical amount by which the first camera deviates from a first target bitrate while generating video content. The second operating parameter of the second camera includes at least one of a second historical bitrate at which the second camera generates video content and a second historical amount by which the second camera deviates from a second target bitrate while generating video content.

In one embodiment, the video surveillance system includes a second storage device and the computing system is adapted to store new video content generated by the first camera or the second camera in the second storage device in response to determining that the storage device will run out of storage capacity.

In one embodiment, the retention policy comprises a first amount of time for which the first video content generated by the first camera remains stored in the storage device. The retention policy comprises a second amount of time for which the second video content generated by the second camera remains stored in the storage device, the second amount of time different than the first amount of time.

In one embodiment, the video surveillance system comprises an access control device adapted to generate security data and the retention policy comprises a third amount of time for which the security generated by the access control device remains stored in the storage device.

In one embodiment, the computing system is further adapted to determine a remaining storage capacity of the storage device and determine when the storage device will run out of storage capacity based in part on the first amount of time, the second amount of time, and the third amount of time.

Other embodiments of the system and method are described in detail below and are also part of the present teachings.

For a better understanding of the present embodiments, together with other and further aspects thereof, reference is made to the accompanying drawings and detailed description, and its scope will be pointed out in the appended claims.

### BRIEF DESCRIPTION OF THE DRAWINGS

FIG. 1 is an illustration of one embodiment of a system, according to the present teachings.

FIG. 2 is a block diagram of a camera that may be implemented in conjunction with a video surveillance system, according to the present teachings.

FIG. 3 is a block diagram of a client computing device that may be implemented in conjunction with a computing system, according to the present teachings.

FIG. 4 is a block diagram of a storage management application that may be implemented by a computing system in conjunction with a video surveillance system, according to the present teachings.

FIGS. 5A-5F illustrate various non-limiting examples of notifications that indicate a future lack of storage capacity available to a video surveillance system, according to the present teachings.

FIG. 6 is a block diagram of a local server that may be implemented in conjunction with a computing system, according to the present teachings.

FIG. 7 is a block diagram of a remote server that may be implemented in conjunction with a computing system, according to the present teachings.

FIG. 8 illustrates an example flow diagram of a process for managing storage of video content for a video surveillance system, according to the present teachings.

FIG. 9 is a flow diagram of method steps for managing storage of video content for a video surveillance system, according to the present teachings.

### DETAILED DESCRIPTION

The present teachings are described more fully hereinafter with reference to the accompanying drawings, in which the present embodiments are shown. The following description is presented for illustrative purposes only and the present teachings should not be limited to these embodiments. Any computer configuration and architecture satisfying the speed and interface requirements herein described may be suitable for implementing the system and method of the present embodiments.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

A “computing system” may provide functionality for the present teachings. The computing system may include software executing on computer readable media that may be logically (but not necessarily physically) identified for particular functionality (e.g., functional modules). The computing system may include any number of computers/processors, which may communicate with each other over a network. The computing system may be in electronic communication with a datastore (e.g., database) that stores control and data information. Forms of computer readable media include, but are not limited to, disks, hard drives, random access memory, programmable read only memory, or any other medium from which a computer can read.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components.

To aid the Patent Office and any readers of a patent issued on this application in interpreting the claims appended hereto, it is noted that none of the appended claims or claim elements are intended to invoke 35 U.S.C. 112 (f) unless the words “means for” or “step for” are explicitly used in the particular claim.

Recitations of numerical ranges by endpoints include all numbers within that range (e.g., 1 to 5 includes 1, 1.5, 2, 2.75, 3, 3.80, 4, 5, etc.). Where a range of values is “greater than”, “less than”, etc., of a particular value, that value is included within the range.

Any direction referred to herein, such as “top,” “bottom,” “left,” “right,” “upper,” “lower,” “above,” below,” and other directions and orientations are described herein for clarity in reference to the figures and are not to be limiting of an actual device or system or use of the device or system. Many of the devices, articles, or systems described herein may be used in a number of directions and orientations.

Any citation to a reference in this disclosure or during the prosecution thereof is made out of an abundance of caution. No citation (whether in an Information Disclosure Statement or otherwise) should be construed as an admission that the cited reference qualifies as prior art or comes from an area that is analogous or directly applicable to the present teachings.

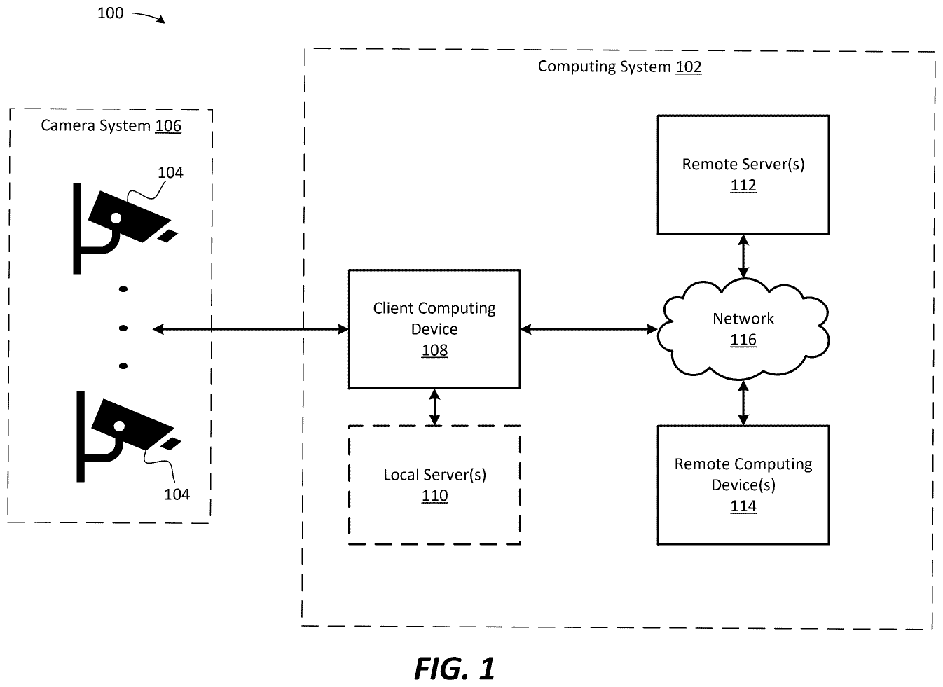

Referring now to FIG. 1, shown is one embodiment of a system 100 according to the present teachings. The system 100 may be, for example, a video surveillance system 100. As shown, the video surveillance system 100 includes a computing system 102 that is in electronic communication with one or more cameras 104 that generate video content. Together, the one or more cameras 104 may form, for example, a camera system 106. In the following description, the one or more cameras 104 may be collectively referred to as a camera 104. The computing system 102 may include any number of computers/processors, which may communicate with each other over a network and rely on distributed computing resources. In some examples, the computing system 102 may be in the form of one or more servers.

In the illustrated example of FIG. 1, the computing system 102 includes a client computing device 108, one or more local servers 110, one or more remote servers 112, and one or more other remote computing devices 114, each of which are connected via a communications network 116. In the following description, the one or more local servers 110 may be collectively referred to as a local server 110, the one or more remote servers 112 may be collectively referred to a remote server 112, and the one or more remote computing devices 114 may be collectively referred to as a remote computing device 114.

The communications network 116 can be, for example, a combination of one or more of a wide area network (WAN) (e.g., the Internet, a TCP/IP based network, a cellular network, such as, for example, a Global System for Mobile Communications [GSM] network, a General Packet Radio Services [GPRS] network, a Code Division Multiple Access [CDMA] network, an Evolution-Data Optimized [EV-DO] network, an Enhanced Data Rates for GSM Evolution [EDGE] network, a 3 GSM network, a 4GSM network, a Digital Enhanced Cordless Telecommunications [DECT] network, a Digital AMPS [IS-136/TDMA] network, or an Integrated Digital Enhanced Network [iDEN] network, etc.), a local area network (LAN), a neighborhood area network (NAN), a home area network (HAN), and/or a personal area network (PAN) employing any of a variety of communications protocols, such as Wi-Fi, Bluetooth, ZigBee, etc.

The one or more cameras 104 generate video content and transmit the generated video content to the client computing device 108. The one or more cameras 104 can be in electrical communication with the client computing device 108 using, for example, a wired connection and/or a wireless connection. The client computing device 108 receives the generated video content from the one or more cameras 104 and stores the generated video content in one or more of a storage device of the client computing device 108, a local server 110 in electrical communication with the client computing device 108, and/or a remote server 112 connected to the client computing device 108 via the communications network 116.

The local server 110 can be, for example, a dedicated on-premises server that is used for storing video content generated by the one or more cameras 104 included in the video surveillance system 100. In this regard, the local server 110 has a finite storage capacity. In some examples, the local server 110 is connected to the client computing device 108 via a local network with a wired and/or or wireless connection. In other examples, the local server 110 is connected to the client computing device 108 via the communications network 116. In some examples, the client computing device 108 and the local server 110 are implemented as a single local computing device. In such examples, the functionality described herein as being performed by the client computing device 108 and the local server 110 can be performed by a single local computing device.

The remote server 112 can be, for example, one or more servers implemented in a cloud-based storage system. Generally, the remote server 112 is equipped to provide an arbitrary amount of storage, compute capacity, and the like. In some examples, access to the remote server 112 is provided on the basis of a subscription or similar model; the subscription may include an allotted amount of storage capacity that is available to the video surveillance system 100. In such examples, when the amount of storage capacity needed to store video content generated by the one or more cameras 104 exceeds the allotted amount of storage capacity that is available to the video surveillance system 100, the operator of the video surveillance system 100 can acquire more storage capacity in the remote server 112 for additional fees. In some examples, the remote server 112 can be connected directly to the one or more cameras 104 via the communications network 116.

As will be described in more detail herein, the client computing device 108 is adapted to manage the storage of video content generated by the one or more cameras 104. For example, the client computing device 108 is adapted to determine an amount of remaining storage capacity in the client computing device 108, the local server 110, and/or the remote server 112 that is available to the video surveillance system 100 for storing video content generated by the one or more cameras 104. In this regard, the client computing device 108 determines, or predicts, when the amount of storage capacity available to the video surveillance system 100 will run out based on one or more operating parameters of the cameras 104 and/or based on retention policies associated with video content generated by one or more cameras 104. The client computing device 108 is further adapted to generate notifications that indicate a future lack of storage capacity available to the video surveillance system 100. The client computing device 108 can present these notifications to an operator of the video surveillance system 100 via a display of the client computing device 108 and/or transmit these notifications to one or more of the remote computing devices 114.

Although not shown, the computing system 102 can further be in electronic communication with one or more security devices such as motion sensors, alarms, access controls (e.g., door locks), and/or any other suitable type of security device. In such examples, the one or more security devices generate security data and transmit the generated security data to the client computing device 108. The client computing device 108 receives the generated security data from the one or more security devices and stores the generated security data in one or more of a storage device of the client computing device 108, the local server 110, and/or the remote server 112. In such examples, the client computing device 108 can be further adapted to manage the storage of security data generated by the one or security devices in a similar manner to video content generated by the cameras 104, as described herein.

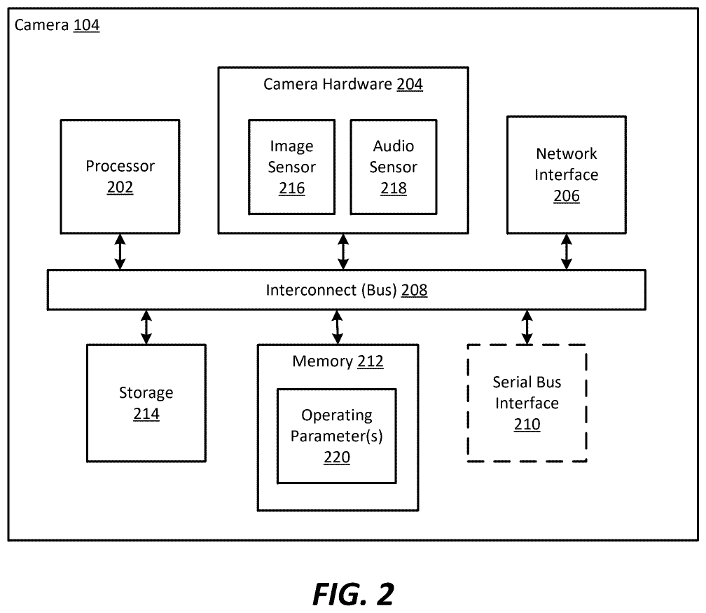

FIG. 2 is a block diagram of a camera 104 that may be implemented in conjunction with the video surveillance system 100, according to present teachings. As shown, the camera 104 may include, without limitation, a processor 202, camera hardware 204, a network interface 206, an interconnect 208, a serial bus interface 210, memory 212, and storage 214. The interconnect, or bus, 208 can include one or more wires, cables, traces, contacts, analog components, digital components, wireless connection components, or other suitable means for interconnecting hardware components of the camera 104. The camera hardware 204 can include, without limitation, an image sensor 216 and an audio sensor 218.

The processor 202 is adapted to control the camera 104 (e.g., the camera hardware 204) to generate video content in accordance with one or more operating parameters 220 included in the memory 212. In some examples, the operating parameters 220 can include one or more of a target bitrate at which the camera 104 generates video content, a target quality for video content generated by the camera 104, a target frame rate at which the camera 104 generates video content, and/or a target file size for video content generated and/or transmitted by the camera 104. In some examples, the target quality is a predetermined value such as pixel count or resolution. In other examples, the target quality for video content is derived from one or more proxy values including at least one of a frame rate value for video content generated by the camera 104, a resolution value for video content generated by the camera, a field of view of the camera 104, or a position of the camera 104.

In some scenarios, the processor 202 deviates from the operating parameters 220, such as the target bitrate and/or target quality, when controlling the camera 104 to generate video content. For example, when an amount of activity detected by the camera 104 exceeds a threshold, the processor 202 may control the camera 104 to generate content with a bitrate that is greater than the target bitrate and/or a quality that is greater than the target quality. In this regard, the operating parameters 220 may further include one or more deviation amounts indicative a deviation in between the actual bitrate, actual quality, and/or actual frame rate of video content generated by the camera 104 and a target bitrate, a target quality, and/or a target frame rate. Other situations in which the camera 104 may deviate from the operating parameters 220 also exist, such as low lighting conditions, poor visibility conditions, and the like.

In one example, the camera 104 is used to generate video content associated with a high traffic area (e.g., busy intersection, interstate, parking garage, etc.). In this example, the processor 202 included in the camera 104 can deviate from the operating parameters 220, such as the target file size for video content generated by the camera 104 and/or a target quality for video content generated by the camera 104, during times in the day at which vehicle traffic is busier (e.g., rush hour). In that regard, the processor 104 may compress video content generated by the camera 104 less efficiently and, therefore, transmits video files that are larger in size to the client computing device 108. Other example scenarios may also result in deviations from the operating parameters, such as different weather conditions (e.g., rain or snow), different lighting conditions (e.g., at night or in low-light situations), and the like.

In some examples, the processor 202 is adapted to transmit, via the network interface 206 and/or the serial bus interface 210, video content to the client computing device 108, the local server 110, and/or the remote server 112 in accordance with one or more operating parameters 220. The operating parameters 220 can include, without limitation, a frequency at which the camera 104 transmits video content to the client computing device 108, the local server 110, and/or the remote server 112. The operating parameters 220 can also include, without limitation, a size (e.g., size in gigabytes) of a video file (e.g., .MP4 file) generated by the camera 104 that is transmitted to the client computing device 108, the local server 110, and/or the remote server 112. In some examples, the processor 202 temporarily stores video content generated by the camera 104 in storage 214 before transmitting the video content to the client computing device 108, the local server 110, and/or the remote server 112.

In some examples, different cameras 104 in the video surveillance system 100 can operate in accordance with different operating parameters 220. For example, a first camera 104 included in the video surveillance system 100 may operate in accordance with a first set of operating parameters 220 (e.g., a first target bitrate, a first target video quality, a first target frame rate, a first target transmission frequency, and/or a first target file size) and a second camera 104 included in the video surveillance system 100 may operate in accordance with a second set of operating parameters 220 (e.g., a second target bitrate, a second target video quality, a second target frame rate, a second target transmission frequency, and/or a second target file size) different than the first set of operating parameters 220.

In some examples, the operating parameters 220 for a camera 104 are defined and/or set by the client computing device 108. For example, the client computing device 108 can be used to commission the cameras 104 in video surveillance system 100 with respective operating parameters 220. In this regard, commissioning a camera 104 with operating parameters 220 can include transmitting, by the client computing device 108, a message containing values for one or more operating parameters 220 to the camera 104. In some examples, the operating parameters 220 for a camera 104 are defined and/or set by the remote server 112. For example, the client remote server 112 can be used to commission the cameras 104 in video surveillance system 100 with respective operating parameters 220. In this regard, commissioning a camera 104 with operating parameters 220 can include transmitting, by the remote server 112, a message containing values for one or more operating parameters 220 to the camera 104. In some examples, a camera 104 can define and set its own operating parameters 220. In such examples, the camera 104 transmits its own operating parameters 220 to the client computing device 108, the local server 110, and/or the remote server 112.

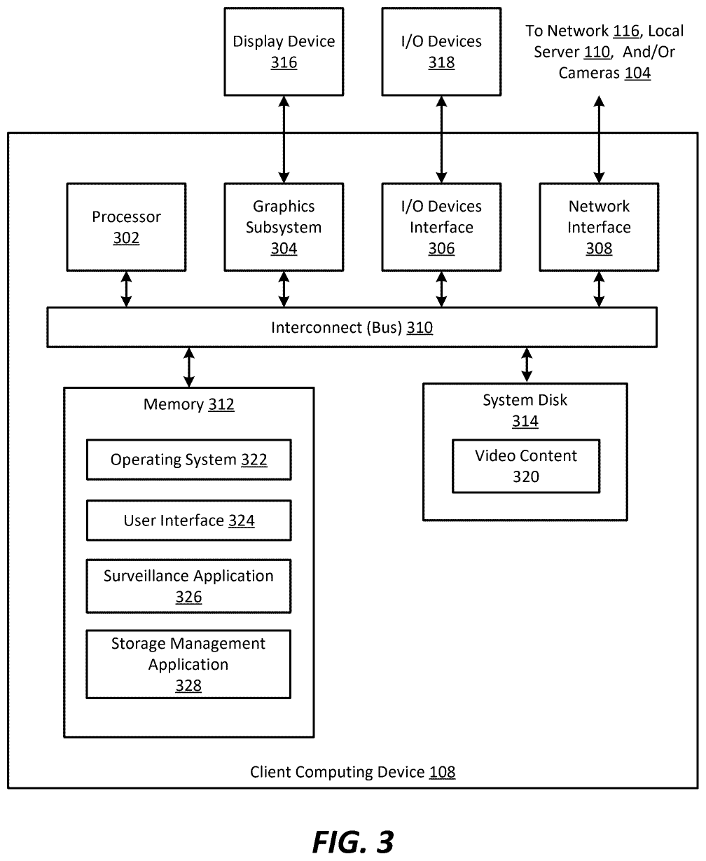

FIG. 3 is a block diagram of a client computing device 108 that may be implemented in conjunction with the computing system 102, according to present teachings. As shown, the client computing device 108 may include, without limitation, a processor 302, a graphics subsystem 304, an I/O device interface 306, a network interface 308, an interconnect 310, a memory subsystem 312, and a system disk 314. The interconnect, or bus, 310 can include one or more wires, cables, traces, contacts, analog components, digital components, wireless connection components, and/or other suitable means for interconnecting hardware components of the client computing device 108.

In some embodiments, the processor 302 (e.g., a CPU or similar processor) is adapted to retrieve and execute programming instructions stored in the memory subsystem 312. Similarly, the processor 302 is adapted to store and retrieve application data (e.g., software libraries) residing in the memory subsystem 312 and/or the system disk 314. The interconnect 310 is adapted to facilitate transmission of data, such as programming instructions and application data, between the processor 302, the graphics subsystem 304, the I/O devices interface 306, the network interface 308, the memory subsystem 312, and the system disk 314.

In some embodiments, the graphics subsystem 304 is adapted to generate frames of image and/or video data and transmit the frames of image and/or video data to display device 316. In some embodiments, the graphics subsystem 304 may be integrated into an integrated circuit, along with the processor 302. The display device 316 may comprise any technically feasible means for generating an image for display. For example, the display device 316 may be fabricated using liquid crystal display (LCD) technology, cathode-ray technology, and light-emitting diode (LED) display technology. The display device 316 may include, for example, one or more monitors.

The input/output (I/O) device interface 306 is adapted to receive input data from user I/O devices 318 and transmit the input data to the CPU 302 via the interconnect 310. For example, user I/O devices 318 may comprise one or more buttons, a keyboard, and a mouse or other pointing device. The I/O device interface 306 also includes an audio output unit adapted to generate an electrical audio output signal. User I/O devices 318 may comprise one or more speakers adapted to generate an acoustic output in response to the electrical audio output signal. In alternative embodiments, the display device 316 may include the speaker. In some examples, one or more cameras 104 can be connected to the client computing device 108 via the I/) device interface 306.

The network interface 308 is adapted to transmit and receive packets of data via the network 120. For example, the network interface 308 is used to receive video content from one or more cameras 104 (e.g., in the form of one or more video files and/or livestreamed video content), transmit video content to the local server 110 and/or the remote server 112, and/or transmit notifications to one or more remote computing devices 114. In some embodiments, the network interface 308 is adapted to communicate using the well-known Ethernet standard. The network interface 308 is coupled to the processor 302 via the interconnect 310.

The system disk 314, such as a hard disk drive or flash memory storage drive, is adapted to store non-volatile data. For example, the system disk 314 stores video content 320 generated by the one or more cameras 104. In some examples, the system disk 314 can also store one or more retention policies for video content stored in the local server 110, the remote server 112, and/or the system disk 314. In some examples, the system disk 314 can also store one or more operating parameters 220 of the cameras 104.

In some embodiments, the memory subsystem 312 includes programming instructions and application data that comprise an operating system 322, a user interface 324, a surveillance application 326, and a storage management application 328. The operating system 322 performs system management functions such as managing hardware devices including graphics subsystem 304, I/O device interface 306, the network interface 308, and system disk 314. The operating system 322 also provides process and memory management models for the user interface 324, the surveillance application 326, and the storage management application 328. The user interface 324, such as a window and object metaphor, provides a mechanism for user interaction with client computing device 108. Persons skilled in the art will recognize the various operating systems and user interfaces that are well-known in the art and suitable for incorporation into the client computing device 108.

In some examples, the surveillance application 326 provides users access to video content generated by the one or more cameras 104 included in the video surveillance system 100. For example, the surveillance application 326 can retrieve and display video content 320 that is stored in the system disk 314, video content stored in the local server 110, and/or video content stored in the remote server 112. In some examples, with the surveillance application 326, a user of the client computing device 108 can also remotely adjust operating parameters 220 of one or more cameras 104 included in the video surveillance system 100. In some examples, the surveillance application 326 and the storage management application 328 are integrated in single application. In such examples, the storage management application 328 can provide the functionality described herein as being performed by the surveillance application 326.

The storage management application 328 manages storage of video content that is generated by the one or more cameras 104 and stored in the system disk 314 of the client computing device 108, in the local server 110, and/or in the remote server 112. In this regard, the storage management application 328 determines, or predicts, if and/or when an amount of storage capacity in the computing system 102 that is available to the video surveillance system 100 (e.g., storage capacity of the local server 110, storage capacity of the remote server 112, and/or storage capacity of the system disk 314) will run out. For example, the storage management application 328 can determine if and/or when a particular storage device (e.g., the local server 110, the remote server 112, and/or the system disk 314) will run out of storage capacity based on a remaining storage capacity of the particular storage device, operating parameters 220 of one or more cameras 104 that are generating video content to be stored in the particular storage device, and one or more retention policies associated with video content stored in the particular storage device. When a particular storage device in the computing system 102 runs out of storage capacity, that particular storage device is unable to store new video content generated by the one or more cameras 104 without first deleting and/or removing currently stored video content.

In some examples, the storage management application 328 can further manage the storage of security data that is generated by one or more security devices (e.g., motion sensors, access control devices, etc.) and stored in the system disk 314 of the client computing device 108, in the local server 110, and/or in the remote server 112. In such examples, description herein of the storage management application 328 with respect to video content generated by one or more cameras 104 can also be applicable to the management of the storage of security data.

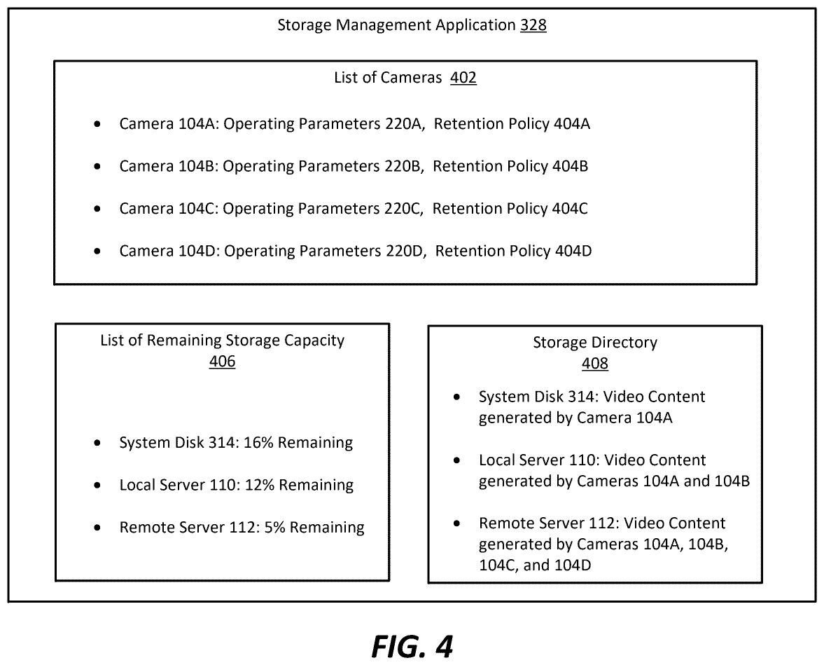

FIG. 4 is a block diagram of the storage management application 328 that may be implemented by the computing system 102 in conjunction with the video surveillance system 100, according to present teachings. Although the storage management application 328 is described and shown (see FIG. 3) as running on the client computing device 108, in some examples, the storage management application 328 can additionally and/or alternatively run on the local server 110 and/or the remote server 112. In some examples, the storage management application 328 is implemented as a distributed service that runs on the client computing device 108, the local server 110, and/or the remote server 112.

As shown, the storage management application 328 maintains a list of cameras 402. The list of cameras 402 includes every camera 104 that is currently active (e.g., generating video content) within the video surveillance system 100. Each entry in the list of cameras 402 includes an identifier associated with a particular camera (e.g., camera 104A, camera 104B, etc.), a corresponding list of operating parameters 220 (e.g., operating parameters 220A, operating parameters 220B, etc.) used by a respective camera 104 in the list of cameras 402, and a corresponding retention policy 404 (e.g., retention policy 404A, retention policy 404B, etc.) associated a respective camera 104 in the list of cameras 402. In some examples, the list of cameras 402 is implemented as a table that is stored in and/or otherwise accessible to the client computing device 108, the local server 110, and/or the remote server 112.

For example, as shown in FIG. 4, a first entry in the list of cameras 402 includes camera 104A, the operating parameters 220A used by the camera 104A, and the retention policy 404A associated with video content generated by the camera 104A. As another example, a second entry in the list of cameras 402 includes camera 104B, the operating parameters 220B used by the camera 104B, and the retention policy 404B associated with video content generated by the camera 104B. As yet another example, a third entry in the list of cameras 402 includes camera 104C, the operating parameters 220C used by the camera 104C, and the retention policy 404C associated with video content generated by the camera 104C. In another example a fourth entry in the list of cameras 402 includes camera 104D, the operating parameters 220D used by the camera 104D, and the retention policy 404D associated with video content generated by the camera 104D. Although the list of cameras 402 includes four cameras 104A-104D in the illustrated example of FIG. 4, persons skilled in the art will understand that more or less than four cameras 104 can be active in the video surveillance system 100.

The cameras 104 included in the video surveillance system 100 can operate using the same operating parameters 220 and/or different operating parameters 220. For example, the operating parameters 220A used by camera 104A can include one or more operating parameters that are the same as one or more of the operating parameters 220B used by camera 104B. As another example, the operating parameters 220A used by camera 104A can include one or more operating parameters that are different than one or more of the operating parameters 220C used by the camera 104C. In some examples, every camera 104 operates in accordance with a single set of operating parameters 220. In other examples, a first group of cameras 104 (e.g., cameras 104A and 104B) in the list of cameras 402 can operate in accordance with a first set of operating parameters 220 (e.g., operating parameters 220A) and a second group of cameras 104 (e.g., cameras 104C and 104D) in the list of cameras 402 can operate in accordance with a second set of operating parameters 220 (e.g., operating parameters 220B).

As described herein with respect to FIG. 2, operating parameters 220 for a particular camera 104 can include one or more of a target bitrate at which the particular camera 104 generates video content, a target quality for video content generated by the particular camera 104, a target frame rate at which the particular camera 104 generates video content, a frequency at which the particular camera 104 transmits video content to the client computing device 108, the local server 110, and/or the remote server 112, and/or a size of a video file (e.g., .MP4 file) that is generated by the camera 104 and transmitted to the client computing device 108, the local server 110, and/or the remote server 112. In some examples, the operating parameters 220 for a particular camera 104 can further include one or more deviation amounts indicative of the amounts by which video content generated by the camera 104 deviates from a target bitrate, a target quality, and/or a target frame rate.

In operation, the storage management application 328 can determine the operating parameters 220 for a particular camera 104 included in the list of cameras 402. As described herein, in some examples, the surveillance application 326 may be used to define and/or set the operating parameters 220 of the cameras 104 included in the video surveillance system 100. For example, an operator of the client computing device 108, the local server 110, and/or the remote server 112 can use the surveillance application 326 to set the operating parameters 220 for each of the one or more cameras 104. Thus, in some examples, the storage management application 328 determines the operating parameters 220 for a particular camera 104 included in the list of cameras 402 by retrieving the operating parameters 220 from the surveillance application 326. In some examples, the storage management application 328 determines the operating parameters 220 for a particular camera 104 included in the list of cameras 402 by retrieving the operating parameters 220 from one or more of the system disk 314, the local server 110, and/or the remote server 112. In some examples, the storage management application 328 can be used to set (e.g., manually and/or automatically) the operating parameters 220 for the one or more cameras 104.

In some examples, the storage management application 328 determines the operating parameters 220 for a particular camera 104 included in the list of cameras 402 based on one or more of the video content generated by and received from the particular camera 104, based on values of the operating parameters 220 included in a message received from the particular camera 104 and/or from another device within the computing system 102, and/or based on metadata that is indicative of the operating parameters 220 and included in messages received from the particular camera 104. For example, the storage management application 328 determines the operating parameters 220A for the camera 104A based on one or more of video content generated by and received from the camera 104A, based on values of the operation parameters 220A that are included in messages received from the camera 104A, and/or based on metadata included in messages received from the camera 104A. In some examples, the storage management application 328 determines and/or updates the respective operating parameters 220 for each camera 104 on a periodic basis (e.g., hourly, daily, weekly, etc.) or on an ad-hoc basis. In some examples, the storage management application 328 polls the one or more cameras 104 for their respective operating parameters 220.

In some examples, video content generated by the respective cameras 104 included in the list of cameras 402 can be stored in accordance with the same retention policy 404 or one or more different retention policies 404. For example, video content generated by each camera 104A-104D in the list of cameras 402 can be stored in the internal storage 214 (e.g., an SD card) of the cameras 104A-104D themselves, in the system disk 314, the local server 110, and/or the remote server 112 in accordance with a single retention policy 404. In another example, video content generated by each camera 104A-104D in the list of cameras 402 can be stored in the internal storage 214 of the cameras 104A-104D themselves, in the system disk 314, the local server 110, and/or the remote server 112 in accordance with a different respective retention policy 404. In that regard, video content generated by the camera 104A can be stored in accordance with the retention policy 404A, video content generated by the camera 104B can be stored in accordance with the retention policy 404B, video content generated by the camera 104C can be stored in accordance with the retention policy 404C, and video content generated by the video camera 104D can be stored in accordance with the retention policy 404D. In some examples, a first retention policy (e.g., retention policy 404A) can be used for storing video content generated by a first set of cameras 104 (e.g., cameras 104A and 104B) and a second retention policy (e.g., retention policy 404B) can be used for storing video content generated by a second set of cameras 104 (e.g., cameras 104C and 104D).

As described herein, a respective retention policy 404 indicates rules for how video content generated by a particular camera 104 remains stored, or is retained, in a storage device (e.g., internal storage 214 of the cameras 104A-104D themselves, system disk 314, the local server 110, and/or the remote server 112). Retention policies may dictate a length of time for which the video content must be stored, a location in which the video content must be stored, a count of redundant storage for a given video content, and the like. In that regard, when video content generated by the camera 104A is stored in a storage device (e.g., internal storage 214 of the cameras 104A-104D themselves, system disk 314, local server 110, and/or remote server 112) for an amount of time that exceeds a time limit indicated by the retention policy 404A, the video content can be deleted and/or removed from the storage device. In some examples in which the computing system 102 includes a local server 110 and a remote server 112, a retention policy 404 can indicate how long video content generated by a particular camera 104 remains stored in the system disk 314 and/or local server 110 before the video content is moved to the remote server 112 for storage.

In some examples, the retention policies 404 can be defined by a user of the storage management application 328. For example, when the storage management application 328 is running on the client computing device 108, a user can interact with the display device 316 and/or the I/O devices 318 to define the respective retention policies 404 associated with video content generated by the one or more cameras 104. In some examples, one or more of the retention policies 404 can be updated, either automatically or manually by a user, based on the remaining storage capacities of storage devices (e.g., local server 110, remote server 112, and/or system disk 314) included in the computing system 102. For example, one or more retention policies 404 can be updated in response to the storage management application 328 determining that the amount of remaining storage capacity available to the video surveillance system 100 will run out and/or decrease below a threshold amount (e.g., less than 5 gigabytes remaining, less than 1% remaining, etc.).

As further shown in FIG. 4, the storage management application 328 maintains a list of remaining storage capacity 406. The list of remaining storage capacity 406 includes the remaining amount of storage capacity of each storage device in the computing system 102 that is available to the video surveillance system 100. In the illustrated example of FIG. 4, the list of remaining storage capacity 406 includes the remaining storage capacity of the system disk 314 (e.g., 16% remaining storage capacity), the remaining storage capacity of the local server 110 (e.g., 12% remaining storage capacity), and the remaining storage capacity of the remote server 112 (e.g., 5% remaining storage capacity), though in other examples the list of remaining storage capacity 406 might also include the remaining storage capacity of the various internal storage 214 of the cameras 104A-104D. In the illustrated example of FIG. 4, the remaining storage capacities of the respective storage devices included in the computing system 102 are indicated as percentages of their respective total storage capacities. In other examples, the remaining storage capacities of the respective storage devices included in the computing system 102 can be indicated as respective amounts (e.g., amounts in gigabytes, amounts in terabytes, etc.) of remaining storage capacity.

In some examples, such as the illustrated example of FIG. 4, the computing system 102 includes a system disk 314, a local server 110, and a remote server 112 that are available to the video surveillance system 100 for storing video content generated by the one or more cameras. In such examples, the list of remaining storage capacity 406 includes the remaining storage capacity of the local server 110, the remaining storage capacity of the remote server 112, and the remaining storage capacity of the system disk 314. In some examples, the computing system 102 does not include a remote server 112 and/or the video surveillance system 100 does not have access to a remote server 112. In such examples, the list of remaining storage capacity 406 may only include the remaining storage capacity of the local server 110 and/or the remaining storage capacity of the system disk 314. In some examples, the computing system 102 does not include a local server 110. In such examples, the list of remaining storage capacity 406 may only include the remaining storage capacity of the remote server 112 and/or the remaining storage capacity of the system disk 314. In some examples, the remaining storage capacity of the remote server 112 corresponds to an amount of storage capacity that is allotted to the video surveillance system 100. In such examples, the allotted amount of storage capacity of the remote server 112 that is available to the video surveillance system 100 can be increased for additional fees.

As further shown in FIG. 4, the storage management application 328 maintains a storage directory 408. The storage directory 408, which can be implemented as a table or similar data structure, keeps track of the respective amounts and storage locations of video content generated by the cameras 104 in the video surveillance system 100. In addition, the storage directory 408 tracks where and for how long video content generated by respective the cameras 104 has been stored in one or more storage devices of the computing system 102. For example, the storage directory 408 tracks the amount of video content generated by camera 104A that is currently stored in the local server 110, the remote server 112, and/or the system disk 314 (e.g., 10 gigabytes in local server 110, 120 gigabytes in remote server 112, 300 megabytes in system disk 314, etc.). Furthermore, for example, the storage directory 408 tracks how long respective pieces, or files, of video content generated by the camera 104A have been stored in respective storage devices of the computing system 102 (e.g., video content file 1 has been stored in local server 110 for 10 days, video content file 2 has been stored in remote server 112 for 25 days, etc.). As a simplified non-limiting example, the storage directory 408 in the illustrated example of FIG. 4 indicates that system disk 314 is currently storing video content generated by camera 104A, the local server 110 is currently storing video content generated by cameras 104A and 104B, and the remote server 112 is currently storing video content generated by cameras 104A-104D.

The storage management application 328 can update the list of remaining storage capacity 406 and/or the storage directory 408 on a periodic basis (e.g., hourly, daily, weekly, etc.) or an ad-hoc basis (e.g., each time new video content is stored in a storage device and/or video content is removed from a storage device). In some examples, the storage management application 328 polls the local server 110, the remote server 112, and/or the system disk 314 for their respective remaining storage capacities. In some examples, the storage management application 328 receives messages from the local server 110, the remote server 112, and/or the system disk 314 that indicate the respective remaining storage capacities of the local server 110, the remote server 112, and/or the system disk 314 on a periodic basis and/or an ad-hoc basis. Similarly, in some examples, the storage management application 328 polls the local server 110, the remote server 112, and/or the system disk 314 for their respective storage contents to update the storage directory 408. In some examples, the storage management application 328 receives messages from the local server 110, the remote server 112, and/or the system disk 314 that indicate their respective storage contents on a periodic basis and/or an ad-hoc basis.

In some examples, in addition to maintaining the list of remaining storage capacity 406, the storage management application 328 predicts a future remaining storage capacity of the system disk 314, a future remaining storage capacity of the local server 110, and/or a future remaining storage capacity of the remote server 112. In such examples, the storage management application 328 can determine a future remaining storage capacity of a respective storage device based on the rate at which the respective storage device receives and stores new video content from one or more video cameras 104, the rate at which video content is removed from the respective storage device as defined by one or more retention policies 404, the rate at which the respective storage device receives and stores new security data from one or more security devices, the rate at which security data is removed from the respective storage device as defined by one or more retention policies 404, one or more operating parameters 220 of the cameras 104, and/or deviations from one or more operating parameters 220 of the cameras 104.

As described herein, the storage management application 328 determines, or predicts, if and/or when the storage device(s) in the computing system 102 (e.g., the local server 110, the remote server 112, and/or the system disk 314) will run out of storage capacity that is available to the video surveillance system 100. For example, the storage management application 328 can determine if and/or when the local server 110 will run out of storage capacity, if and/or when the remote server 112 will run out of an allotted amount of storage capacity, and/or if and/or when the system disk 314 will run out of storage capacity. When a particular storage device in the computing system 102 runs out of storage capacity, that particular storage device is unable to store new video content generated by the one or more cameras 104 without first deleting and/or removing currently stored video content. For examples in which the particular storage device is a remote server 112, additional storage capacity in the remote server 112 can be purchased to store new video content generated by the one or more cameras 104 when the remote server 112 runs out of an allotted amount of storage capacity.

The storage management application 328 can determine if, or whether, a particular storage device (e.g., the local server 110, the remote server 112, and/or the system disk 314) will run out of storage capacity based on a remaining storage capacity of the particular storage device, one or more operating parameters 220 of the cameras 104 that are generating video content to be stored in the particular storage device, historical deviations from one or more operating parameters 220 of the cameras, one or more retention policies 404 associated with video content stored in the particular storage device, and/or predicted values for the remaining storage capacity of the particular storage device. In response to determining that the particular storage device will run out of storage capacity, the storage management application 328 can further determine when (e.g., a date, a time, etc.) the particular storage device will run out of storage capacity using the remaining storage capacity of the particular storage device and one or more other factors such as, but not limited to, a rate at which new video content is stored in the particular storage device, storage capacity that will be freed up by removing old video content from the particular storage device, and/or other factors associated with the operating parameters 220 of the cameras 104 and/or the retention policies 404. For example, the storage management application 328 can determine when a particular storage device (e.g., the local server 110, the remote server 112, and/or the system disk 314) will run out of storage capacity based on a remaining storage capacity of the particular storage device, one or more operating parameters 220 of the cameras that are generating video content to be stored in the particular storage device, and one or more retention policies 404 associated with video content stored in the particular storage device.

In one particular example, the storage management application 328 determines whether the local server 110 will run out of storage capacity based on one or more operating parameters 220 of the cameras 104 that are active in the video surveillance system 100, as indicated by the list of cameras 402, and based on the respective retention policies 404 associated with video content that is currently stored in the local server 110, as indicated by the list of cameras 402 and the storage directory 408. In this example, in response to determining that the local server 110 will run out of storage capacity, the storage management application 328 can further determine when the local server 110 will run out of storage capacity based on the remaining storage capacity of the local server 110, as indicated by the list of remaining storage capacity 406, based on one or more operating parameters 220 of the cameras 104 that are active in the video surveillance system 100, and based on the respective retention policies 404 associated with video content that is currently stored in the local server 110. In this example, the storage management application 328 can further predict when the local server 110 will run out of storage capacity based on historical deviations from the operating parameters 220 of the cameras 104 that are active in the video surveillance system 100.

In another particular example, the storage management application 328 determines whether the remote server 112 will run out of an allotted amount of storage capacity based on one or more operating parameters 220 of the cameras 104 that are active in the video surveillance system 100, as indicated by the list of cameras 402, and based on the respective retention policies 404 associated with video content that is currently stored in the remote server 112, as indicated by the list of cameras 402 and the storage directory 408. In this example, in response to determining that the remote server 112 will run out of an allotted amount of storage capacity, the storage management application 328 can further determine when the remote server 112 will run out of the allotted amount storage capacity based on the remaining allotted amount of storage capacity in the remote server 112, as indicated by the list of remaining storage capacity 406, based on the operating parameters 220 of the one or more cameras 104 that are active in the video surveillance system 100, and based on the respective retention policies 404 associated with video content that is currently stored in the remote server 112. Furthermore, in response to determining that the remote server 112 will run out of an allotted amount of storage capacity, the storage management application 328 can acquire additional storage capacity in the remote server 112 for storing video content generated by the one or more cameras before an allotted amount of storage capacity in the remote server 112 runs out.

In some examples, the storage management application 328 can determine whether a particular storage device (e.g., local server 110, remote server 112, and/or system disk 314) will run out of storage capacity by determining whether the rate at which the particular storage device receives new video content generated by the one or more cameras 104 exceeds the rate at which the particular storage device deletes and/or removes video content that is currently stored in the particular storage device.

The storage management application 328 can determine a rate at which the particular storage device receives new video content generated by the one or more cameras 104 based on respective operating parameters 220 of the cameras 104 that are active in the video surveillance system 100. As described herein, the operating parameters 220 of a camera 104 can include one or more target metrics (e.g., target bitrate, target quality, target frame rate, etc.) for video content generated by the camera 104, a frequency (e.g., periodically, on an ad-hoc basis, etc.) at which the camera 104 transmits video content for storage in a particular storage device, and/or a size of the video files (e.g., .MP4 files) generated by the camera 104. In this regard, in one example, the storage management application 328 can determine a rate (e.g., gigabytes per minute, gigabytes per hour, etc.) at which a particular storage device receives video content from one or more cameras based on the respective target metric(s) for video content generated by the one or more cameras and the frequencies at which the one or more cameras 104 transmit video content for storage in the particular storage device. In another example, the storage management application 328 can determine a rate (e.g., gigabytes per minute, gigabytes per hour, etc.) at which a particular storage device receives video content from one or more cameras 104 based on the respective sizes of the video files generated by the one or more cameras 104 and the rates at which the one or more cameras 104 transmit the video files for storage.

In addition, the storage management application 328 can determine a rate at which the particular storage device (e.g., local server 110, remote server 112, and/or system disk 314) deletes and/or removes video content that is currently stored in the particular storage device based on respective retention policies 404 associated with the video content that is currently stored in the particular storage device. As described herein, a respective retention policy 404 indicates how long video content generated by a particular camera 104 remains stored in a particular storage device. For example, a first retention policy 404A can indicate how long video content generated by a first camera 104A remains stored in a particular storage device and a second retention policy 404B can indicate how long video content generated by a second camera 104B remains stored in the particular storage device.

When the rate at which a particular storage device receives new video content generated by one or more cameras 104 exceeds the rate at which the particular storage device deletes and/or removes video content that is currently stored in the particular storage device, the storage management application 328 determines that the particular storage device will run out of storage capacity. In response to determining that the particular storage device will run out of storage capacity, the storage management application 328 can further determine when (e.g., a date and/or a time) the particular storage device will run out of storage capacity based on the remaining storage capacity of the particular storage device, the rate at which a particular storage device receives new video content generated by one or more cameras 104, and the rate at which the particular storage device deletes and/or removes video content that is currently stored in the particular storage device.

As described herein, in some examples, a camera 104 may deviate from one or more target metrics (e.g., target bitrate, target quality, target frame rate, etc.) when generating video content. In such examples, the operating parameters 220 of the camera 104 can be updated to include the respective deviation amounts between actual metrics (e.g., actual bitrate, actual quality, actual frame rate, etc.) of video content generated by the camera 104 and the target metrics for video content generated by the camera 104. In this regard, the storage management application 328 can determine whether and/or when a particular storage device will run out of storage capacity based in part on the respective deviation amounts included in the operating parameters 220 of a camera 104.

In some examples, the respective amounts by which a camera 104 deviates from one or more target metrics when generating video content can be determined by the camera 104 and/or determined by the storage management application 328. For example, the storage management application 328 can analyze video content received from a camera 104 to determine a deviation amount between an actual metric (e.g., actual bitrate, actual quality, actual frame rate, etc.) of the video content received form the camera 104 and a target metric (e.g., target bitrate, target quality, target frame rate, etc.) for video content generated by the camera 104.

After determining whether a particular storage device will run out of storage capacity, the storage management application 328 can generate a notification based on the determination. For example, the storage management application 328 can generate a notification that indicates the particular storage device will not run out of storage capacity in response to determining that the particular storage device will not run out of storage capacity. As another example, the storage management application 328 can generate a notification, or alert, that indicates the particular storage device will run out of storage capacity and/or when the particular storage device will run out of storage capacity in response to determining that the particular storage device will run out of storage capacity. The storage management application 328 can then present the notification to a user via the display device 316 of the client computing device 108 and/or transmit the notification to one or more remote computing devices 114 via the communications network 116.

The information included in the notification generated by the storage management application 328 can vary depending one or more of whether the particular storage device will run out of storage capacity, when the particular storage device will run out of storage capacity, whether the particular storage device is a system disk 314, whether the particular storage device is a local server 110, and/or whether the particular storage is a remote server 112.

For examples in which the storage management application 328 determines that the particular storage device will not run out of storage capacity, the notification generated by the storage management application 328 can include one or more of an indication that particular storage device will not run out of storage capacity, an indication of the remaining amount of storage capacity in the particular storage device, and/or an indication of how much storage capacity of the particular storage device has been used.

For examples in which the storage management application 328 determines that the particular storage device will run out of storage capacity and the particular storage device is a local server 110, the notification, or alert, generated by the storage management application 328 can include an indication that the local server 110 will run out of storage capacity, an indication as to when (e.g., an time, a date, a countdown, etc.) the local server 110 will run out of storage capacity, an indication of the remaining amount of storage capacity of the local server 110, and/or the amount of storage capacity in the local server 110 that has been used. In some examples in which the storage management application 328 determines that the particular storage device will run out of storage capacity and the particular storage device is a local server 110, the notification generated by the storage management application 328 can include a warning that video content will be lost.

In some examples in which the storage management application 328 determines that the particular storage device will run out of storage capacity and the particular storage device is a local server 110, the notification generated by the storage management application 328 can include a recommendation for preventing loss of video content. A recommendation to prevent loss of video content can include a recommendation to reduce a number of cameras 104 that are generating video content, a recommendation to change one or more operating parameters 220 of a camera 104 (e.g., recommendation to reduce bit rate, reduce video quality, reduce frame rate, etc.), a recommendation to change a retention policy 404 associated with video content stored in the local server 110 (e.g., a recommendation to reduce the amount of time for which video content generated by a particular camera 104 remains stored in the local server 110), and/or a recommendation to upload video content stored in the local server 110 to a remote server 112 and/or similar cloud-based storage device.

For examples in which the storage management application 328 determines that the particular storage device will run out of storage capacity and the particular storage device is a remote server 112, the notification, or alert, generated by the storage management application 328 can include an indication that the remote server 112 will run out of an allotted amount of storage capacity, an indication as to when (e.g., an time, a date, a countdown, etc.) the remote server 112 will run out of an allotted amount of storage capacity, an indication of the remaining allotted amount of storage capacity of the remote server 112, and/or how much of the allotted amount of storage capacity in the remote server 112 that has been used. In some examples in which the storage management application 328 determines that the particular storage device will run out of storage capacity and the particular storage device is a remote server 112, the notification generated by the storage management application 328 can include a warning that video content will be lost unless the allotted amount of storage capacity in the remote server 112 is increased.

In some examples in which the storage management application 328 determines that the particular storage device will run out of storage capacity and the particular storage device is a remote server 112, the notification generated by the storage management application 328 can include a recommendation for preventing loss of video content. A recommendation to prevent loss of video content can include a recommendation to reduce a number of cameras 104 that are generating video content, a recommendation to change one or more operating parameters 220 of a camera 104 (e.g., recommendation to reduce bit rate, reduce video quality, reduce frame rate, etc.), a recommendation to change a retention policy 404 associated with video content stored in the remote server 112 (e.g., a recommendation to reduce the amount of time for which video content generated by a particular camera 104 remains stored in the remote server 112), and/or a recommendation to acquire and/or purchase additional storage capacity in the remote server 112. In some cases, the recommendation may indicate an estimated cost for the amount of additional storage capacity likely to be required to adequately preserve the video content mandated by the retention policy 404 without loss of video content.

In some examples, the cameras 104 included in the video surveillance system 100 can be ordered and/or categorized according to a priority schedule. For example, cameras 104 that generate video content associated with relatively high traffic areas and/or areas of high importance can be considered to be of a higher priority than cameras 104 that generate video content associated with relatively low traffic areas and/or areas of low importance. In such examples, a recommendation for preventing the loss of video content can be generated in accordance with the priority schedule for the cameras 104. In that regard, in one example, the storage management application 328 can generate a recommendation to alter operating parameters 220 (e.g., reduce bitrate, reduce framerate, reduce quality, etc.) of a camera 104 that is of relatively low priority and/or to disconnect a camera 104 that is of relatively low priority from a particular storage device. In another example, the storage management application 328 can generate a recommendation to reassign cameras 104 to different storage devices based on the priority schedule for the cameras 104. For example, the storage management application 328 can generate a recommendation that recommends reassigning a low priority camera 104 that is connected to a storage device that will run out of storage capacity to a different storage device. As another example, the storage management application 328 can generate a recommendation that recommends reassigning a high priority camera 104 to a storage device that has a large amount of remaining storage capacity.

In some examples, the storage management application 328 determines that a particular storage device (e.g., the system disk 314 or the local server 110) will run out of remaining storage capacity because the particular storage device is unable to offload stored video content to one or more other storage devices (e.g., one or more remote servers 112). For example, according to some retention policies, a particular storage device (e.g., the system disk 314 or the local server 110) stores respective video content for a particular amount of time (e.g., 30 days) and then offloads the video content to a cloud-based storage device (e.g., remote server 112) for long term storage after expiration of the particular amount of time. In such examples, if the network connection between the particular storage device and the cloud-based storage device goes down, is throttled, and/or the like, the storage management application 328 will be unable to offload the video content from the particular storage device to the cloud-based storage device. In that regard, for instances in which the storage management application 328 determines that the particular storage device (e.g., the system disk 314 or the local server 110) will run out of remaining storage capacity because the network connection of the particular storage device is down and/or throttled, the storage management application 328 can generate a notification that includes a recommendation to check network settings, to check a network connection, and/or to perform some other action associated with the network connection of the particular storage device.

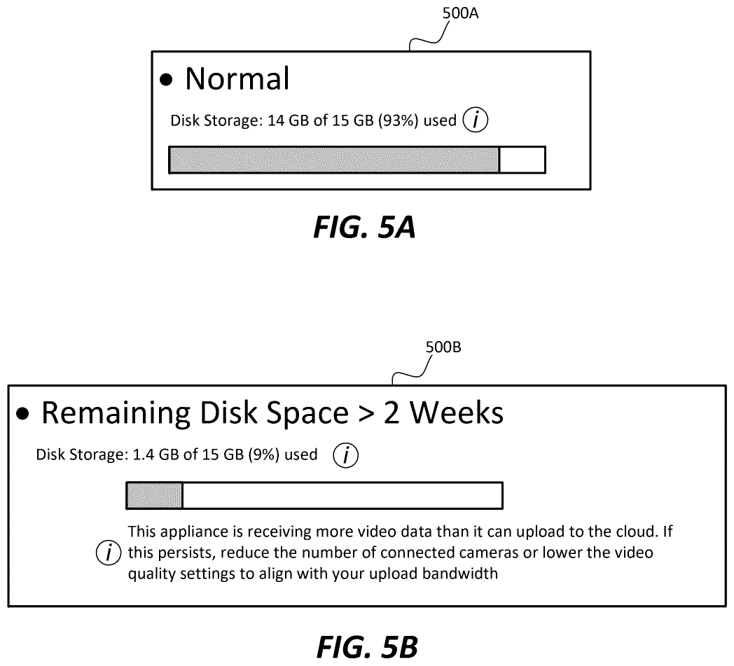

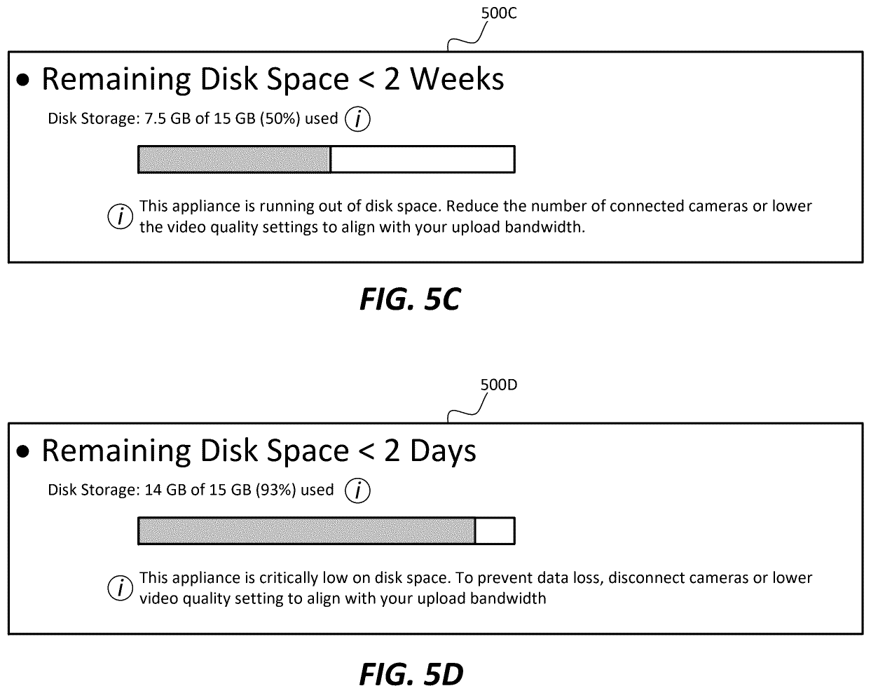

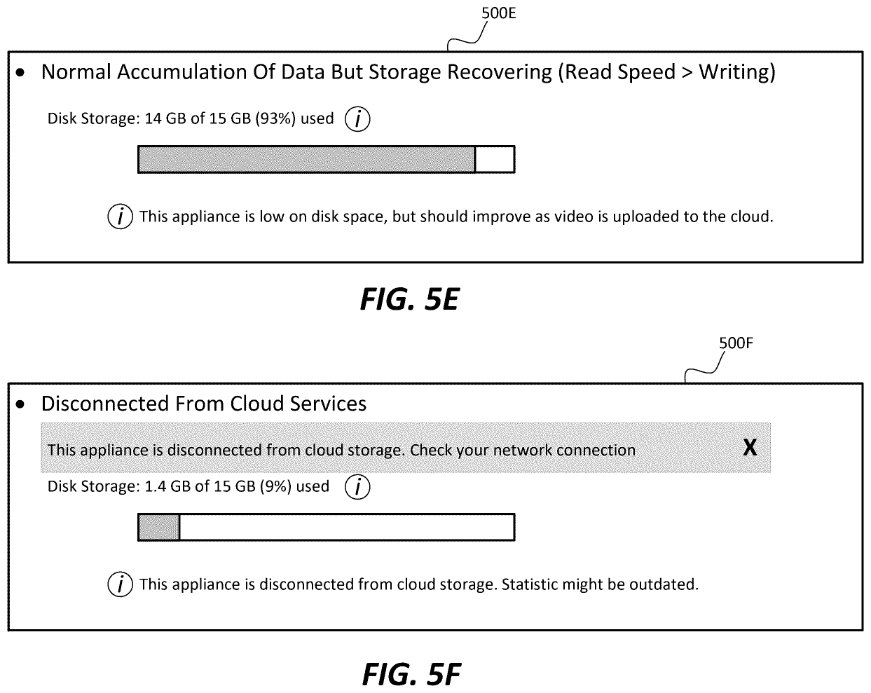

FIGS. 5A-5F illustrate various non-limiting example notifications that indicate a future lack of storage capacity available to the video surveillance system 100, according to present teachings. The notifications shown in FIGS. 5A-5F can be generated by storage management application 328 and presented to a user via the display device 316 of the client computing device 108. The storage management application 328 can also transmit the notifications to one or more remote computing devices 114.

FIG. 5A illustrates a first non-limiting example notification 500A that can be generated by the storage management application 328 and presented to a user via the display device 316 of the client computing device 108. As shown in FIG. 5A, the notification 500A indicates that the condition of a video content stored in a storage device (e.g., local server 110, remote server 112, and/or system disk 314) is normal (e.g., the storage device will not run out of capacity). The notification 500A also indicates that 14 gigabyte (GB), or 93%, of the 15 GB storage capacity of the storage device has been used.

FIG. 5B illustrates a second non-limiting example notification 500B that can be generated by the storage management application 328 and presented to a user via the display device 316 of the client computing device 108. As shown in FIG. 5B, the notification 500B indicates that the storage device will run out of storage capacity in more than two weeks because the storage device is receiving more video content than it can upload to the remote server 112 and/or a similar cloud-based storage device. The notification 500B further recommends reducing the number of cameras 104 that generate video content and/or reducing the quality and/or bitrate of video content generated by the cameras 104. In addition, the notification 500B indicates that 1.4 GB, or 9%, of the 15 GB storage capacity of the storage device has been used.

FIG. 5C illustrates a third non-limiting example notification 500C that can be generated by the storage management application 328 and presented to a user via the display device 316 of the client computing device 108. As shown in FIG. 5C, the notification 500C indicates that the storage device will run out of storage capacity in less than two weeks. The notification 500C further recommends reducing the number of cameras 104 that generate video content and/or reducing the quality and/or bitrate of video content generated by the cameras 104. In addition, the notification 500C indicates that 7.5 GB, or 50%, of the 15 GB storage capacity of the storage device has been used.

FIG. 5D illustrates a fourth non-limiting example notification 500D that can be generated by the storage management application 328 and presented to a user via the display device 316 of the client computing device 108. As shown in FIG. 5D, the notification 500D indicates that the remaining disk space in the storage device is critically low and that the storage device will run out of storage capacity in less than two days. The notification 500D further recommends reducing the number of cameras 104 that generate video content and/or reducing the quality and/or bitrate of video content generated by the cameras 104. In addition, the notification 500C indicates that 14 GB, or 93%, of the 15 GB storage capacity of the storage device has been used.

FIG. 5E illustrates a fifth non-limiting example notification 500E that can be generated by the storage management application 328 and presented to a user via the display device 316 of the client computing device 108. As shown in FIG. 5E, the notification 500E indicates that the storage device is low on disk space, but that storage capacity will improve as video content is uploaded from the storage device to a remote server 112 and/or a cloud-based storage device. In addition, the notification 500E indicates that 14 GB, or 93%, of the 15 GB storage capacity of the storage device has been used.

FIG. 5F illustrates a sixth non-limiting example notification 500F that can be generated by the storage management application 328 and presented to a user via the display device 316 of the client computing device 108. As shown in FIG. 5F, the notification 500F indicates that the storage device is disconnected from a remote server 112 and/or a cloud-based storage device. Moreover, the notification 500F recommends checking the network connection of the storage device.

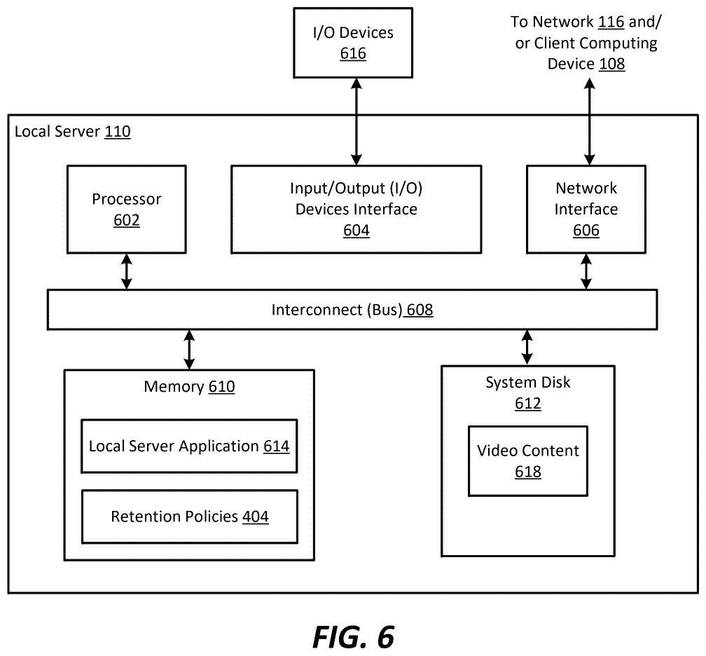

FIG. 6 is a block diagram of a local server 110 that may be implemented in conjunction with the computing system 102 of FIG. 1, according to present teachings. As shown in FIG. 6, the local server 110 includes, without limitation, a processor 602, an input/output (I/O) devices interface 604, a network interface 606, an interconnect 608, a system memory 610, and a system disk 612. The interconnect, or bus, 608 can include one or more wires, cables, traces, contacts, analog components, digital components, wireless connection components, and/or other suitable means for interconnecting hardware components of the local server 110.

The processor 602 is adapted to retrieve and execute programming instructions, such as local server application 614, stored in the system memory 610. Similarly, the processor 602 is adapted to store application data (e.g., software libraries) and retrieve application data from the system memory 610. The interconnect 608 is adapted to facilitate transmission of data, such as programming instructions and application data, between the processor 602, I/O devices interface 604, the network interface 606, the system memory 610, and the system disk 612. The I/O devices interface 604 is adapted to receive input data from I/O devices 616 and transmit the input data to the processor 602 via the interconnect 608. For example, I/O devices 616 may include one or more buttons, a keyboard, a mouse, and/or other input devices. The I/O devices interface 604 is further adapted to receive output data from the processor 602 via the interconnect 608 and transmit the output data to the I/O devices 616.

The system disk 612 may include one or more hard disk drives, solid state storage devices, or similar storage devices. The system disk 612 has a limited, or finite, storage capacity. The system disk 612 is adapted to application files, software libraries, etc.). For example, the system disk 612 is adapted to store video content 618 generated by one or more cameras 104 in the video surveillance system 100.

The system memory 610 includes a local server application 614 that manages the storage of video content 618 in the system disk 612 in accordance with one or more retention policies 404. As described herein, the retention policies 404 indicate how long video content 618 generated by particular cameras 104 should remain stored in system disk 612. For example, the retention policies 404 can include a first amount of time (e.g., 45 days) for which video content 618 generated by a first camera 104 should remain stored in the system disk 612, a second amount of time (e.g., 60 days) for which video content 618 generated by a second camera 104 should remain stored in the system disk 612, a third amount of time (e.g., 120 day) for which video content 618 generated by a third camera 104 should remain stored in the system disk 612. In some examples, the retention policies 404 indicate that video content 618 generated by a first set of cameras 104 should remained stored in the system disk 612 for a first amount of time and that video content 618 generated by a second set of cameras 104 should remain stored in the system disk 612 for a second, different amount of time.

In operation, the local server application 614 receives video content generated by the one or more cameras 104 from the client computing device 108 and/or directly from the one or more cameras 104 via the communications network 116. The local server application 614 then stores the received video content as video content 618 in the system disk 612 in accordance with the retention policies 404. Furthermore, the local server application 614 removes particular video content 618 from the system disk 612 when the amount of time for which the particular video content 618 has been stored in the system disk 612 exceeds the storage time indicated by the retention policies 404. For example, if the retention policies 404 indicate that video content 618 generated by a first camera 104 should be stored in system disk 612 for 45 days, the local server application 614 removes the video content 618 generated by the first camera 104 from the system disk 612 after the video content 618 generated by the first camera 104 has been stored in the system disk 612 for 45 days. Removing video content 618 from the system disk 612 can include deleting the video content 618 and/or transmitting the video content 618 to a remote server 112 for storage. The local server application 614 can also retrieve video content 618 stored in the system disk 612 in response to receiving a request for the video content 618 from the client computing device 108 and/or a remote computing device 114.

In some examples, the local server application 614 can update the list of remaining storage capacity 406 and/or the storage directory 408 described herein with respect to FIG. 4. In that regard, the local server application 614 can transmit a message that indicates the remaining amount of storage capacity in the system disk to the client computing device 108 and/or to the remote server 112, depending on where the storage management application 328 is run. The local server application 614 can also transmit information that indicates how much video content 618 generated by a respective camera 104 is stored in the system disk 612 and for how long the video content 618 generated by the respective camera 104 has been stored in the system disk 612. In some examples, the local server 614 can perform one or more of the storage management functions described herein as being performed by the storage management application 328. In some examples, the local server 110 can additionally run the storage management application 328. In some examples, the local server application 614 and the storage management application 328 are integrated and implemented as a single application that can run on the client computing device 108, the local server 110, and/or the remote server 112.

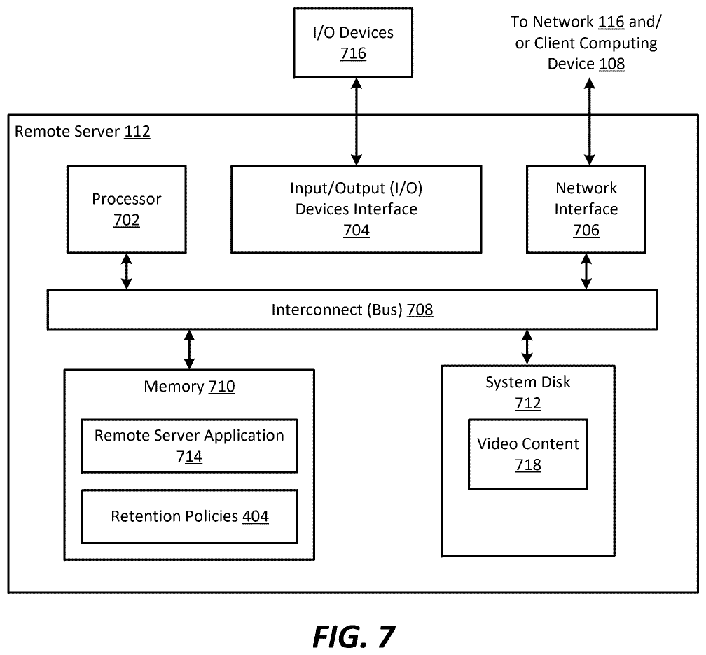

FIG. 7 is a block diagram of a remote server 112 that may be implemented in conjunction with the computing system 102 of FIG. 1, according to present teachings. Similar to the local server 110 shown in FIG. 6, as shown in FIG. 7, the remote server 112 includes, without limitation, a processor 702, an input/output (I/O) devices interface 704, a network interface 706, an interconnect 708, a system memory 710, and a system disk 712. The interconnect, or bus, 708 can include one or more wires, cables, traces, contacts, analog components, digital components, wireless connection components, and/or other suitable means for interconnecting hardware components of the remote server 112.

The processor 702 is adapted to retrieve and execute programming instructions, such as remote server application 714, stored in the system memory 710. Similarly, the processor 702 is adapted to store application data (e.g., software libraries) and retrieve application data from the system memory 710. The interconnect 708 is adapted to facilitate transmission of data, such as programming instructions and application data, between the processor 702, I/O devices interface 704, the network interface 706, the system memory 710, and the system disk 712. The I/O devices interface 704 is adapted to receive input data from I/O devices 716 and transmit the input data to the processor 702 via the interconnect 708. For example, I/O devices 716 may include one or more buttons, a keyboard, a mouse, and/or other input devices. The I/O devices interface 704 is further adapted to receive output data from the processor 702 via the interconnect 708 and transmit the output data to the I/O devices 716.

The system disk 712 may include one or more hard disk drives, solid state storage devices, or similar storage devices. The system disk 712 has an allotted amount of storage capacity that is available to the video surveillance system 100. The allotted amount of storage capacity in the system disk 712 may be variable, for instance being increased for additional fees, decreased for a rebate, or the like. The system disk 712 is adapted to application files, software libraries, etc.). For example, the system disk 712 is adapted to store video content 718 generated by one or more cameras 104 in the video surveillance system 100.

The system memory 710 includes a remote server application 714 that manages the storage of video content 718 in the system disk 712 in accordance with one or more retention policies 404. As described herein, the retention policies 404 indicate how long video content 718 generated by particular cameras 104 should remain stored in system disk 712. For example, the retention policies 404 can include a first amount of time (e.g., 45 days) for which video content 404 generated by a first camera 104 should remain stored in the system disk 712, a second amount of time (e.g., 60 days) for which video content 404 generated by a second camera 104 should remain stored in the system disk 712, and a third amount of time (e.g., 120 day) for which video content 718 generated by a third camera 104 should remain stored in the system disk 712. In some examples, the retention policies 404 indicate that video content 718 generated by a first set of cameras 104 should remain stored in the system disk 712 for a first amount of time and that video content 718 generated by a second set of cameras 104 should remain stored in the system disk 712 for a second, different amount of time.

In operation, the remote server application 714 receives video content generated by the one or more cameras 104 from the client computing device 108 and/or directly from the one or more cameras 104 via the communications network 116. The remote server application 714 then stores the received video content as video content 718 in the system disk 712 in accordance with the retention policies 404. Furthermore, the remote server application 714 removes particular video content 718 from the system disk 712 when the amount of time for which the particular video content 718 has been stored in the system disk 712 exceeds the storage time indicated by the retention policies 404. For example, if the retention policies 404 indicate that video content 718 generated by a first camera 104 should be stored in system disk 712 for 45 days, the remote server application 714 removes the video content 718 generated by the first camera 104 from the system disk 712 after the video content 718 generated by the first camera 104 has been stored in the system disk 712 for 45 days. Removing video content 718 from the system disk 712 can include deleting the video content 718 and/or transmitting the video content 718 to a different remote server 112 for storage. The remote server application 714 can also retrieve video content 718 stored in the system disk 712 in response to receiving a request for the video content 718 from the client computing device 108 and/or a remote computing device 114.

In some examples, the remote server application 714 can update the list of remaining storage capacity 406 and/or the storage directory 408 described herein with respect to FIG. 4. In that regard, the remote server application 714 can transmit a message that indicates a remaining allotted amount of storage capacity in the system disk 712 to the client computing device 108 and/or to the local server 110, depending on where the storage management application 328 is run. The remote server application 714 can also transmit information that indicates how much video content 718 generated by a respective camera 104 is stored in the system disk 712 and for how long the video content 718 generated by the respective camera 104 has been stored in the system disk 712. In some examples, the remote server application 714 can acquire additional storage capacity in the system disk 712.

In some examples, the remote storage application 714 can perform one or more of the storage management functions described herein as being performed by the storage management application 328. In some examples, the remote server 112 can additionally run the storage management application 328. In some examples, the remote server application 714 and the storage management application 328 are integrated and implemented as a single application that can run on the client computing device 108, the local server 110, and/or the remote server 112.

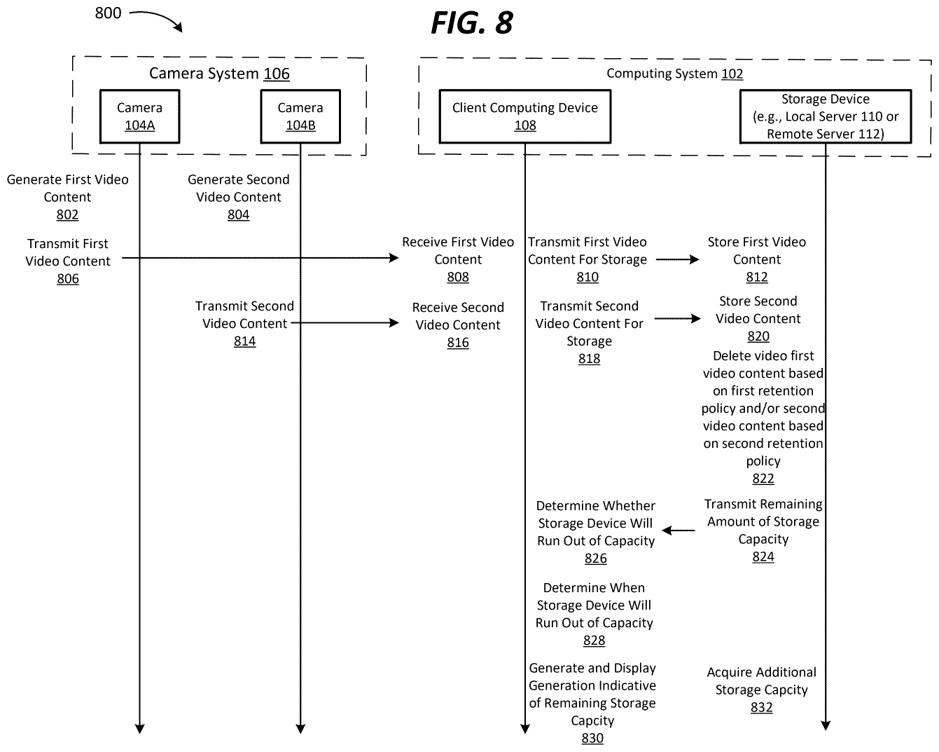

FIG. 8 illustrates an example flow diagram of a process 800 for managing storage of video content for a video surveillance system, according to the present teachings. Although the interaction between the devices in process 800 are shown in an order, persons skilled in the art will understand that the interactions may be performed in a different order, interactions may be repeated or skipped, and/or may be performed by components other than those described in FIG. 8.

In the illustrated example of FIG. 8, the computing system 102 is shown as including a client computing device 108 and a storage device, which can be implemented as a local server 110 or a remote server 112. However, persons skilled in the art will understand that the computing system 102 can include more than one storage device and that actions described as being performed by the client computing device 108 can alternatively and/or additionally be performed directly by the storage device. Furthermore, in the illustrated example of FIG. 8, the camera system 106 connected to the computing system 102 is shown as including a first camera 104A and a second camera 104B. However, persons skilled in the art will understand that the image generation system 106 can include more or less than two cameras 104.

Process 800 begins at step 802 at which the first camera 104A generates first video content. For example, the first camera 104A generates first video content in accordance with first operating parameters 220A for the first camera 104A. At step 804, the second camera 104B generates second video content. For example, the second camera 104B generates second video content in accordance with second operating parameters 220B for the second camera 104B.

At step 806, the first camera 104A transmits the first video content to the client computing device 108. In some examples, the first video content transmitted by the first camera 104A is accompanied by metadata including one or more first operating parameters 220A for the first camera 104A, an identifier of the first camera 104A, timestamps associated with generation and/or transmission of the first video content, analytics information that describes the presence, movement, and/or characteristics of objects included in the first video content, and/or other information associated with the first camera 104A and/or the first video content.

At step 808, the client computing device 108 receives the first video content. For example, the storage management application 328 running on the client computing device 108 receives the first video content. At step 810, the client computing device 108 transmits the first video content to the storage device. For example, the storage management application 328 running on the client computing device 108 transmits the first video content to the storage device.

The storage device can be implemented as, for example, a local server 110 or a remote server 112. At step 812, the storage device stores the first video content. For example, the local server application 614 and/or the remote server application 714 running on the storage device stores the first video content.

At step 814, the second camera 104B transmits the second video content to the client computing device 108. In some examples, the second video content transmitted by the second camera 104B is accompanied by metadata including one or more second operating parameters 220B for the second camera 104B, an identifier of the second camera 104B, timestamps associated with generation and/or transmission of the second video content, analytics information that describes the presence, movement, and/or characteristics of objects included in the second video content, and/or other information associated with the second camera 104B and/or the second video content.

At step 816, the client computing device 108 receives the second video content. For example, the storage management application 328 running on the client computing device 108 receives the second video content. At step 818, the client computing device 108 transmits the second video content to the storage device. For example, the storage management application 328 running on the client computing device 108 transmits the second video content to the storage device.

At step 820, the storage device stores the second video content. For example, the local server application 614 and/or the remote server application 714 running on the storage device stores the second video content.

At step 822, the storage device deletes and/or removes first video content that was previously generated by the first camera 104A and stored in the storage device in accordance with a first retention policy. For example, the local server application 614 and/or the remote server application 714 running on the storage device deletes and/or removes first video content stored in the storage device when the first video content has been stored in the storage device for an amount of time indicated by a first retention policy 404A associated with video content generated by the first camera 104A. Additionally and/or alternatively, at step 822, the storage device deletes and/or removes second video content that was previously generated by the second camera 104B and stored in the storage device in accordance with a second retention policy. For example, the local server application 614 and/or the remote server application 714 running on the storage device deletes and/or removes second video content stored in the storage device when the second video content has been stored in the storage device for an amount of time indicated by a second retention policy 404B associated with video content generated by the second camera 104B.

At step 824, the storage device transmits a message indicating a remaining amount of storage capacity in the storage device to the client computing device. For an example in which the storage device is a local server 110, the local server application 614 transmits a message indicating the remaining amount of storage capacity in the system disk 612. For an example in which the storage device is a remote server 112, the remote server application 714 transmits a message indicating the remaining allotted amount of storage capacity in the system disk 712.

At step 826, using one or more of the present teachings described herein, the client computing device 108 determines whether the storage device will run out of storage capacity based in part on one or more of the first operating parameters 220A, one or more of the second operating parameters 220B, the first retention policy, and the second retention policy. For example, the storage management application 328 running on the client computing device 108 determines whether the storage device will run out of storage capacity based on one or more of the first operating parameters 220A, one or more of the second operating parameters 220B, the first retention policy 404A, and the second retention policy 404B.

As described herein, the one or more first operating parameters 220A include, for example, one or target metrics (e.g., target bitrate, target quality, target frame rate, etc.) for video content generated by the first camera 104A, a deviation between a target metric and an actual metric of video content generated by the first camera 104A, a frequency (e.g., periodically, on an ad-hoc basis, etc.) at which the first camera 104A transmits video content to the client computing device 108, and/or a size of a video file generated by the first camera 104A. The storage management application 328 may determine the one or more first operating parameters 220A used to determine whether the storage device will run out of capacity by retrieving the one or more first operating parameters 220A from the surveillance application 326, system disk 314, the local server 110, and/or the remote server 112. In some examples, the storage management application 328 determines the one or more first operating parameters 220A based on metadata that accompanied the first video content received from the first camera 104A.

Similarly, as described herein, the one or more second operating parameters 220B include, for example, one or target metrics (e.g., target bitrate, target quality, target frame rate, etc.) for video content generated by the second camera 104B, a deviation between a target metric and an actual metric of video content generated by the second camera 104B, a frequency (e.g., periodically, on an ad-hoc basis, etc.) at which the second camera 104B transmits video content to the client computing device 108, and/or a size of a video file generated by the second camera 104B. The storage management application 328 may determine the one or more second operating parameters 220B used to determine whether the storage device will run out of capacity by retrieving the one or more second operating parameters 220B from the surveillance application 326, system disk 314, the local server 110, and/or the remote server 112. In some examples, the storage management application 328 determines the one or more second operating parameters 220B based on metadata that accompanied the first video content received from the second camera 104B.

If at step 826 the client computing device 108 determines that the storage device will run out of storage capacity, at step 828, the client computing device 108 determines when the storage device will run out of storage capacity based in part on the remaining amount of storage capacity in the storage device, one or more of the first operating parameters 220A, one or more of the second operating parameters 220B, the first retention policy, and the second retention policy. For example, the storage management application 328 running on the client computing device 108 determines when the storage device will run out of storage capacity based on the remaining amount of storage capacity in the storage device, one or more of the first operating parameters 220A, one or more of the second operating parameters 220B, the first retention policy 404A, and the second retention policy 404B.

At step 830, the client computing device 108 generates and displays a notification that indicates whether the storage device will run out of storage capacity. For example, the storage management application 328 running on the client computing device 108 generates and displays a notification, such as one of the example notifications 500A-500F, to indicate whether the storage device will run out of storage capacity. As described herein, the notification can include one or more of an indication as to whether the storage device will run out of storage capacity, an indication as to when the storage device will run out of storage capacity, the remaining amount of storage capacity in the storage device, an amount of storage capacity in the storage device that has been used, and/or a recommendation for preventing loss of video content stored in the storage device and/or generated by the cameras 104A, 104B.

At step 832, the storage device acquires additional storage capacity. For example, when the storage device is implemented as a remote server 112, the remote server application 714 can acquire additional storage capacity in the system disk 712 of the remote server 112. As another example, when the storage device is implemented as a local server 110, acquiring additional storage capacity can include uploading video content stored in the system disk 614 of the local server 110 to a remote server 112 for storage.

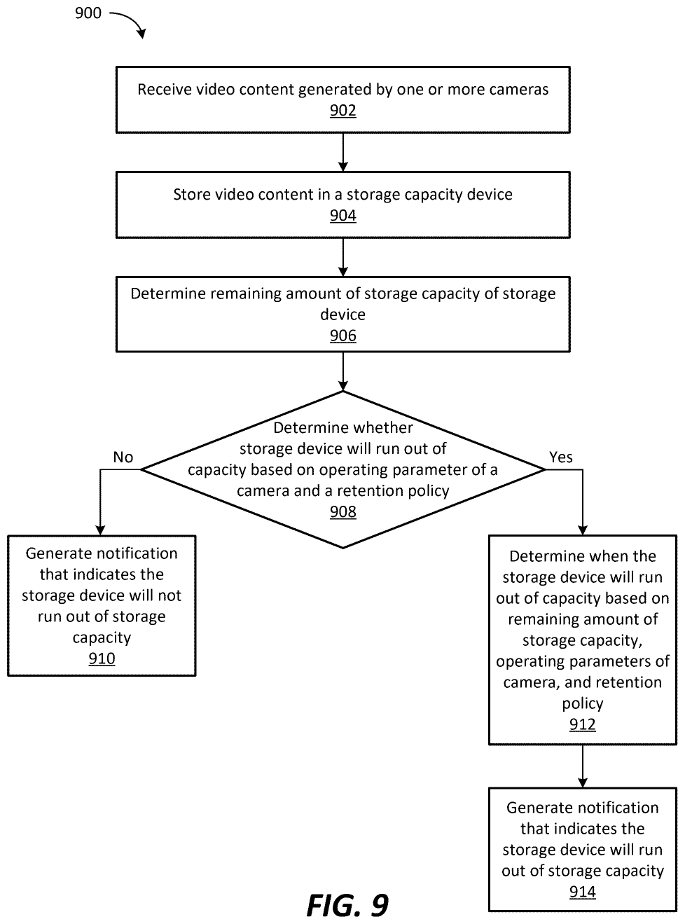

FIG. 9 is a flow diagram of method steps for managing storage of video content for a video surveillance system, according to the present teachings. Although the method steps are described with reference to the systems and processes of FIGS. 1-8, persons skilled in the art will understand that any system adapted to implement the method steps, in any order, falls within the scope of the present invention.

As shown, a method 900 begins at step 902, where video content generated by one or more cameras is received. For example, the computing system 102 receives video content generated by a plurality of cameras 104.

At step 904, the video content received at step 902 is stored in a storage device. For example, the computing system 102 stores the video content in a storage device (e.g., the local server 110, the remote server 112, or the system disk 314).

At step 906, a remaining amount storage capacity of the storage device is determined. For example, the computing system 102 determines a remaining amount of storage capacity of the storage device (e.g., the local server 110, the remote server 112, or the system disk 314).

At step 908, it is determined whether the storage device will run out of storage capacity based on an operating parameter of the camera and a retention policy associated with video content stored in the storage device. For example, the computing system 102 determines whether the storage device (e.g., the local server 110, the remote server 112, or the system disk 314) will run out of storage capacity based on an operating parameter (e.g., a target bitrate for video content generated by the camera 104, a target quality for video content generated by the camera 104, a target frame rate for video content generated by the camera 104, a deviation between the target and an actual bitrate of video content generated by the camera 104, a deviation between target quality and an actual quality of video content generated by the camera 104, a deviation between a target frame rate and an actual frame of video content generated by the camera 104, a frequency at which the camera 104 transmits video content to the computing system 102, and/or a size of a video file generated by the camera 104) of the camera 104 and/or a retention policy associated with video content stored in the storage device. The retention policy can, for example, indicate how long video content generated by the camera 104 remains stored in the storage device.

If, at step 908, it is determined that the storage device will not run out of storage capacity, the method 900 proceeds to step 910. At step 910, a notification that indicates the storage device will not run out of storage capacity is generated. For example, the computing system 102 generates a notification that indicates storage of video content is normal in response to determining that the storage device (e.g., the local server 110, the remote server 112, or the system disk 314) will not run out of storage capacity.

If, at step 908, it is determined that the storage device will run out of storage capacity, the method 900 proceeds to step 912. At step 912, a time, date, and/or countdown to when the storage device will run out of storage capacity is determined based on the remaining amount of storage capacity of the storage device, the operating parameter of the camera, and the retention policy associated with video content stored in the storage device. For example, the computing system 102 determines when the storage device (e.g., the local server 110, the remote server 112, or the system disk 314) will run out of storage capacity based on the remaining amount of storage capacity of the storage device, an operating parameter of the camera 104, and a retention policy associated with video content stored in the storage device.

At step 914, a notification indicating that the storage device will run out of storage capacity and/or when the storage device will run out of storage capacity is generated. For example, the computing system 102 generates a notification that indicates the storage device (e.g., the local server 110, the remote server 112, or the system disk 314) will run out of storage capacity and/or when (e.g., a time, a date, a countdown, etc.) the storage device will run out of storage capacity.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable processors.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings.

What is claimed is:

1. A video surveillance system, comprising:
video content generated by a camera;
a storage device; and
a computing system adapted to receive the video content from the camera;
the computing system adapted to store the video content in the storage device;
the computing system adapted to determine whether the storage device will run out of storage capacity based on an operating parameter of the camera and a retention policy associated with the video content stored in the storage device; and
the computing system adapted to generate an alert in response to determining that the storage device will run out of storage capacity.

2. The video surveillance system of claim 1, wherein the computing system is further adapted to:
determine a remaining storage capacity of the storage device; and
determine when the storage device will run out of storage capacity based on the remaining storage capacity of the storage device, the operating parameter of the camera, and the retention policy associated with video content stored in the storage device.

3. The video surveillance system of claim 2, wherein the alert indicates when the storage device will run out of storage capacity.

4. The video surveillance system of claim 1, wherein the operating parameter of the camera includes a target quality for video content generated by the camera.

5. The video surveillance system of claim 4, wherein the target quality for video content is derived from one or more proxy values including at least one of a frame rate value for video content generated by the camera, a resolution value for video content generated by the camera, a field of view of the camera, or a position of the camera.

6. The video surveillance system of claim 1, wherein the operating parameter of the camera includes an amount by which a quality of the video content generated by the camera deviates from a target quality for video content generated by the camera.

7. The video surveillance system of claim 1, wherein the operating parameter of the camera includes at least one of a bit rate or a frame rate at which the camera generates video content.

8. The video surveillance system of claim 1, wherein the operating parameter of the camera includes a rate at which the camera transmits video content to the computing system.

9. The video surveillance system of claim 1, wherein the retention policy includes an amount of time for which the video content generated by the camera remains stored in the storage device.

10. The video surveillance system of claim 1, wherein the camera is a first camera of a plurality of cameras;
wherein the retention policy comprises a first amount of time for which first video content generated by the first camera remains stored in the storage device; and
wherein the retention policy comprises a second amount of time for which second video content generated by a second camera included in the plurality of cameras remains stored in the storage device.

11. The video surveillance system of claim 1, wherein the alert indicates the remaining capacity of the storage device.

12. The video surveillance system of claim 1, wherein the alert includes a recommendation for preserving the remaining capacity of the storage device.

13. The video surveillance system of claim 1, wherein the storage device is a local server that is connected to the computing system via a local network connection.

14. The video surveillance system of claim 1, wherein the storage device is a remote server that is connected to the computing system via an Internet connection.

15. The video surveillance system of claim 1, further comprising:
a plurality of display devices; and
a plurality of cameras.

16. A video surveillance system, comprising:
a plurality of cameras adapted to generate video content;
a storage device; and
a computing system adapted to receive video content from the plurality of video cameras;
the computing system adapted to store the video content in the storage device;
the computing system adapted to determine a first rate at which video content is stored in the storage device based on one or more operating parameters of the plurality of cameras;
the computing system adapted to determine a second rate at which video content is removed from the storage device based on one or more retention policies associated with video content stored in the storage device;
the computing system adapted to determine whether the storage device will run out of capacity based in part on a comparison between the first rate and the second rate; and
responsive to determining that the storage device will run out of capacity, the computing system adapted to generate an alert that indicates the storage device will run out of storage capacity.

17. The video surveillance system of claim 16, wherein the computing system comprises a plurality of processors in communication over a network.

18. The video surveillance system of claim 16, wherein the computing system is further adapted to:
determine a remaining storage capacity of the storage device; and
determine when the storage device will run out of storage capacity based on the remaining storage capacity of the storage device, the first rate, and the second rate.

19. A video surveillance system, comprising:
first video content generated by a first camera;
second video content generated by a second camera;
a storage device; and
a computing system adapted to receive the first video content from the first camera and the second video content from the second camera;
the computing system adapted to store the first video content and the second video content in the storage device;
the computing system adapted to determine whether the storage device will run out of storage capacity based in part on a first operating parameter of the first camera, a second operating parameter of the second camera, and a retention policy associated with the first video content and the second video content stored in the storage device; and
the computing system adapted to generate an alert in response to determining that the storage device will run out of storage capacity.

20. The video surveillance system of claim 1, wherein the first operating parameter of the first camera includes a first rate at which the first camera transmits video content to the computing system; and
wherein the second operating parameter of the second camera includes a second rate at which the second camera transmits video content to the computing system.

21. The video surveillance system of claim 1, wherein the first operating parameter of the first camera includes at least one of a first historical bitrate at which the first camera generates video content and a first historical amount by which the first camera deviates from a first target bitrate while generating video content; and
wherein the second operating parameter of the second camera includes at least one of a second historical bitrate at which the second camera generates video content and a second historical amount by which the second camera deviates from a second target bitrate while generating video content.

22. The video surveillance system of claim 1, further comprising a second storage device;
wherein the computing system is adapted to store new video content generated by the first camera or the second camera in the second storage device in response to determining that the storage device will run out of storage capacity.

23. The video surveillance system of claim 1, wherein the retention policy comprises a first amount of time for which the first video content generated by the first camera remains stored in the storage device; and
wherein the retention policy comprises a second amount of time for which the second video content generated by the second camera remains stored in the storage device, the second amount of time different than the first amount of time.

24. The video surveillance system of claim 23, further comprising an access control device adapted to generate security data;
wherein the retention policy comprises a third amount of time for which the security generated by the access control device remains stored in the storage device.

25. The video surveillance system of claim 24, wherein the computing system is further adapted to:
determine a remaining storage capacity of the storage device; and
determine when the storage device will run out of storage capacity based in part on the first amount of time, the second amount of time, and the third amount of time.
